(19) United States
(12) Patent Application Publication
(10) Pub. No.: US 2026/0162113 A1
(43) Pub. Date: Jun. 11, 2026

(54) SINGLE TAP PAYMENT TRANSACTIONS

(71) Applicant: American Express Travel Related Services Company, Inc., New York, NY (US)

(72) Inventors: Alaric M. Eby, Scottsdale, AZ (US); Ajay Babu Maddukuri, Phoenix, AZ (US); Mukund Shankar SimhaRaghu, Glendale, AZ (US)

(21) Appl. No.: 18/973,445

(22) Filed: Dec. 9, 2024

(51) Int. Cl. G06Q 20/40; G06Q 20/04; G06Q 20/32; G06Q 20/38; G06Q 30/0226

(52) U.S. Cl. CPC G06Q 20/40145; G06Q 20/047; G06Q 20/3278; G06Q 20/389; G06Q 30/0226

(57) ABSTRACT

Disclosed are various embodiments for a single tap payment transaction. First, a user of a computing device can be authenticated. Then, in response to authentication of the user, the user can be prompted to select a payment credential. Next, the payment credential and a digital identity document associated with the user can be provided to a payment terminal in data communication with the computing device through an NFC radio. Subsequently, a receipt for a transaction can be received from the payment terminal, the receipt indicating that payment for the transaction was made with the payment credential and that an identity of the user was verified with the digital identity document.

### BACKGROUND

Transactions often require the exchange of multiple credentials. Moreover, these credentials are often in different media. For example, someone may need to present both a credit card and a copy of his or her identification documents when checking into a hotel room, purchasing a plane ticket, renting a car, paying for prescription medicine, etc. In addition, individuals may also be members of a merchant's loyalty program, which could require the user to present proof of membership (e.g., scanning a membership card, a bar-code shown on a display of a mobile phone or smartwatch, etc.). As another example, individuals may also need to provide additional documentation for certain types of goods or services (e.g., proof of current health insurance when paying for medicine at a pharmacy). These documents may also be represented using different media. For instance, a user might pay with a mobile wallet application installed on his or her smartphone or smart watch, but have to present a physical copy of his or her driver's license and then open an application installed on his or her smartphone or smartwatch to present a bar code to prove that he or she is a member of the loyalty program of the merchant.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1-9 are drawings depicting an example user experience according to various embodiments of the present disclosure.

FIG. 10 is schematic block diagram depicting a client device and a payment terminal in data communication according to various embodiments of the present disclosure.

FIGS. 11 and 12 are sequence diagrams illustrating one example of interactions between the client device and payment terminal of FIG. 10 according to various embodiments of the present disclosure.

### DETAILED DESCRIPTION

Disclosed are various approaches for simplifying the payment experience of users. When a user uses his or her client device (e.g., mobile phone, wearable device, etc.), additional information can be transmitted from the client device to the payment terminal for particular transactions. For example, in addition to payment information, a digital copy of the user's identification document that verifies the identity of the user can also be transmitted. The payment terminal can then evaluate and verify both the payment information and the identification document to determine whether or not to proceed with the transaction. Additional information, such as merchant loyalty or rewards program enrollment information, can also be transmitted.

By sharing the additional, enriched data, with the payment terminal, the payment terminal can make more intelligent decisions about whether and how to process the transaction. Moreover, by transmitting all relevant information during a single “tap-to-pay” transaction, the payment process is simplified because the user does not have to present multiple documents in series. The simplified payment process allows the payment terminal to be used to process more payments and transactions per period of time because less time is spent obtaining information from the user during the purchase and payment process.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

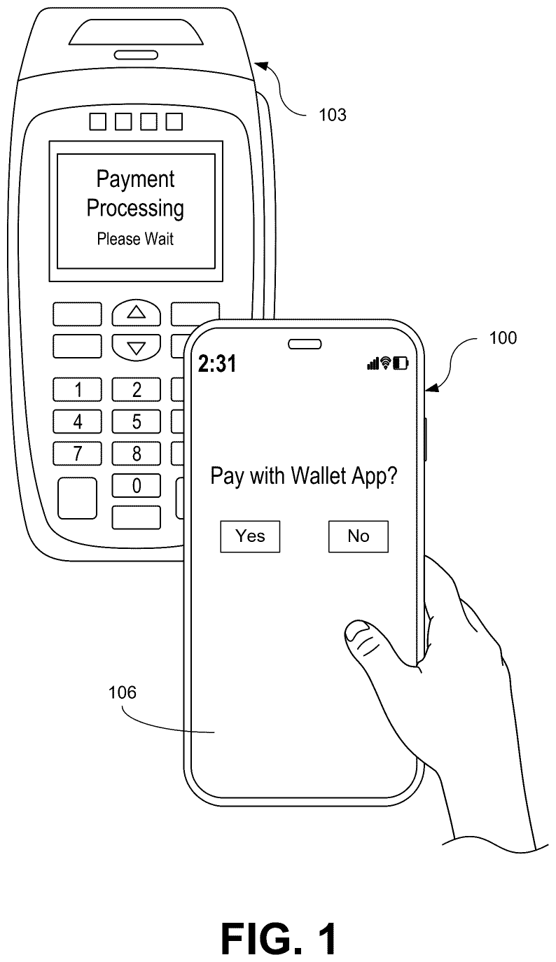

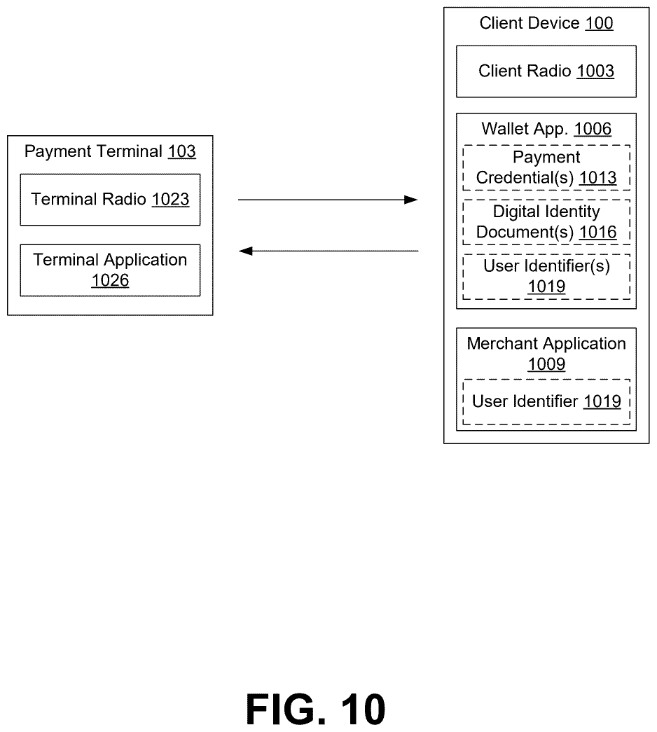

FIG. 1 illustrates the beginning of an example user experience according to various embodiments of the present disclosure. As shown, a user has placed his or her client device 100 in proximity to a payment terminal 103, which can be referred to as “tap-to-pay”). This could be done, for example, to pay for a transaction with a merchant. In response, a user interface is shown on the display 106 of the client device 100, which prompts the user to consent to or confirm payment using a wallet application 1006 (FIG. 10) installed on his or her client device 100.

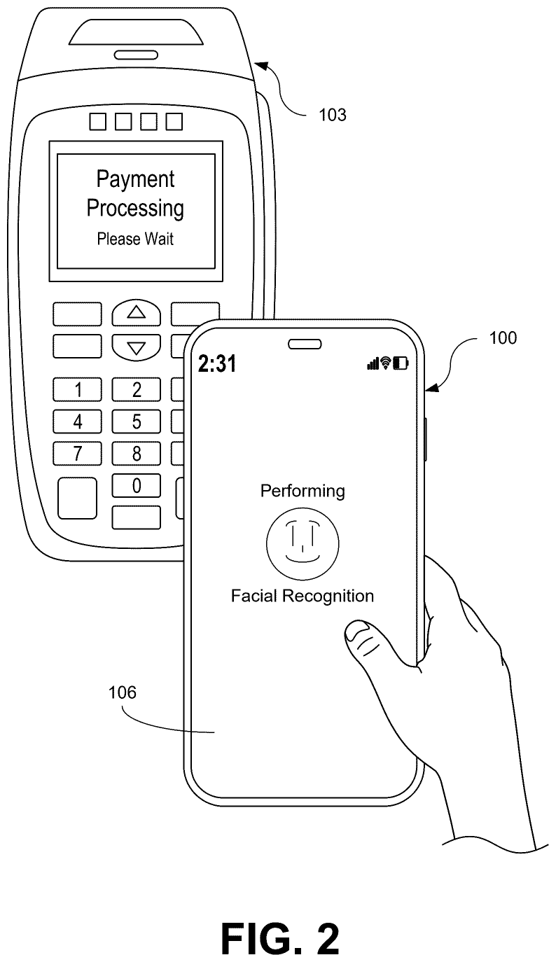

Subsequently, as illustrated in FIG. 2, the client device 100 could authenticate the identity of the user. For example, the client device 100 could perform facial recognition to determine the identity of the user making the payment with the client device 100. If the facial recognition is successful, then the payment journey could continue. Other types of authentication to prove the identity of the user could also be used in various embodiments of the present disclosure, such as performing a fingerprint scan with a built-in fingerprint reader, prompting the user to enter a password or personal identification number (PIN), etc.

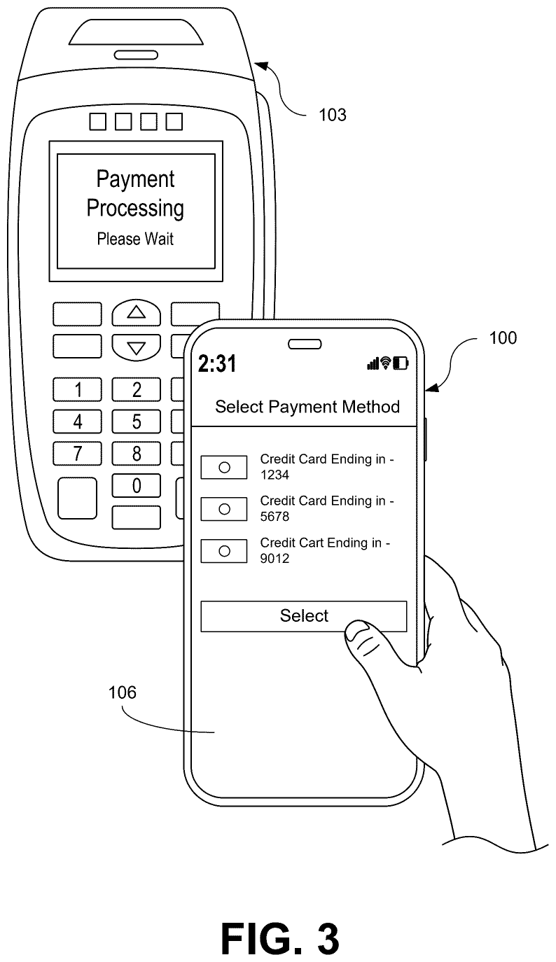

Assuming that authentication is successful, the user could be presented on the display 106 of the client device 100 with a list of potential methods of payment, as depicted in FIG. 3. A selection of at least one method of payment could be obtained through the user interface displayed.

After the user has selected the payment credential, the client device 100 could transmit the payment credential to the payment terminal 103. In addition, the client device 100 could also transmit a digital identity document 1016 (FIG. 10) stored on the client device 100. In some instances, the digital identity document 1016 could be selected automatically. For example, the payment terminal 103 could specify the type of digital identity document(s) 1016 that need to be provided and the client device 100 could respond with any matching digital identity document(s) 1016. In other instances, the user could be prompted to select one or more stored digital identity documents 1016 to be transmitted to the payment terminal 103 to complete the transaction.

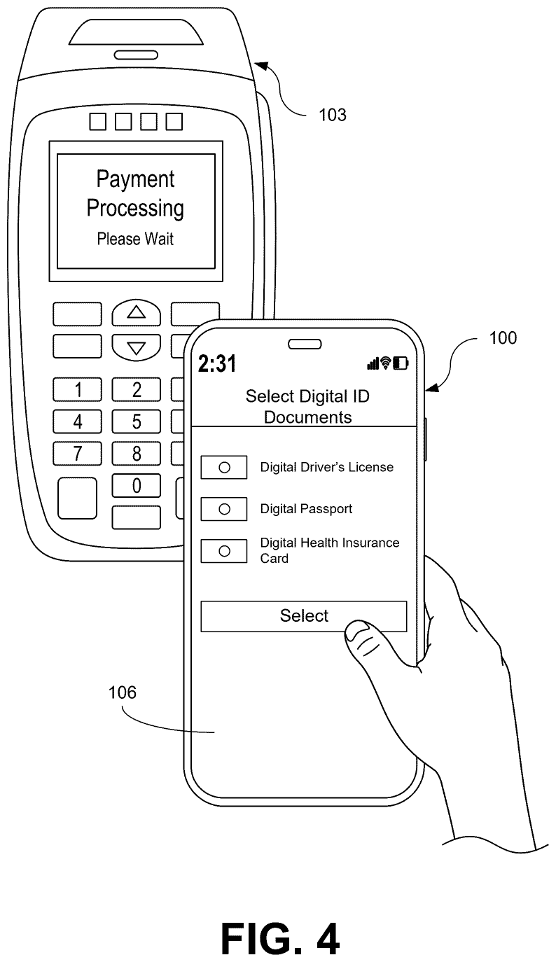

FIG. 4 depicts an example of how a user could be prompted to select one or more digital identity documents 1016. For example, a user could select a digital driver's license or a digital passport to prove their identity or citizenship. As another example, a user could select his or her digital health insurance card to prove enrollment in a health insurance program that entitles him or her to benefits for medical treatments or procedures and prescription medications.

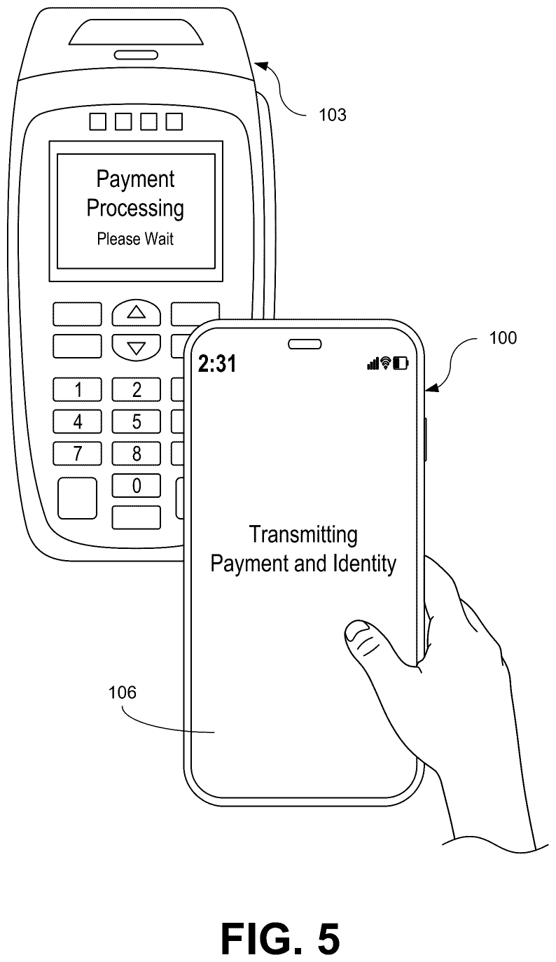

Once the user has selected the digital identity documents 1016, or has had the digital identity documents 1016 automatically selected, the payment credential 1013 and digital identity documents 1016 could be transmitted to the payment terminal 103 to complete the transaction. As shown in FIG. 5, the status of the transmission could be shown on the display 106 of the client device 100 to the user.

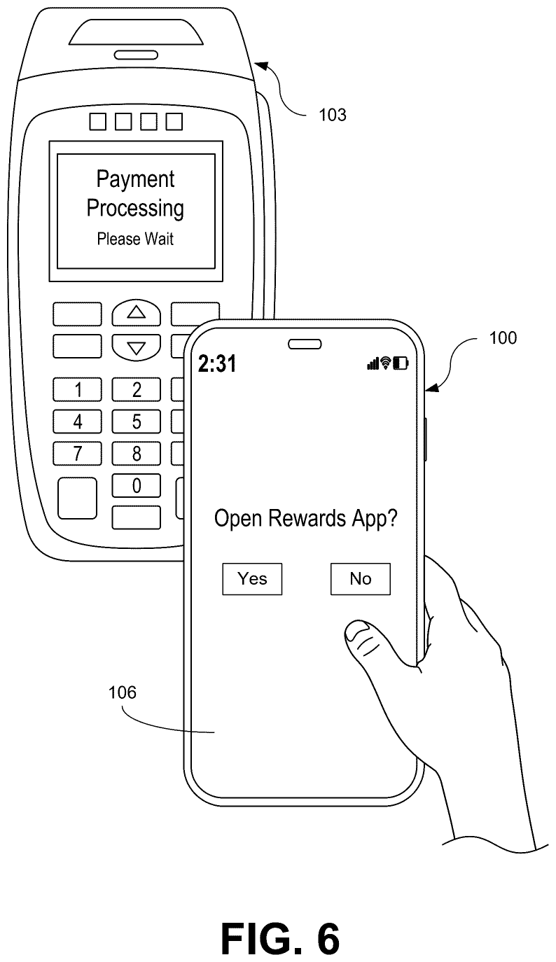

Subsequently, at FIG. 6, the client device 100 could receive a request from the payment terminal 103 to open a merchant application installed on the client device 100. For example, the payment terminal 103 could have sent a deeplink to the client device 100 to cause the client device 100 to open the merchant application to obtain loyalty program information about the user. However, if the client device 100 does not have a merchant application installed on the client device 100, then the deeplink could cause the client device 100 to download and installed the merchant application. Accordingly, loyalty program information would be obtained from current customers while customers who are unenrolled would be prompted to enroll by downloading and installing the merchant application. As depicted in FIG. 5, the user could be prompted to consent to opening the merchant application (or downloading and installing the application).

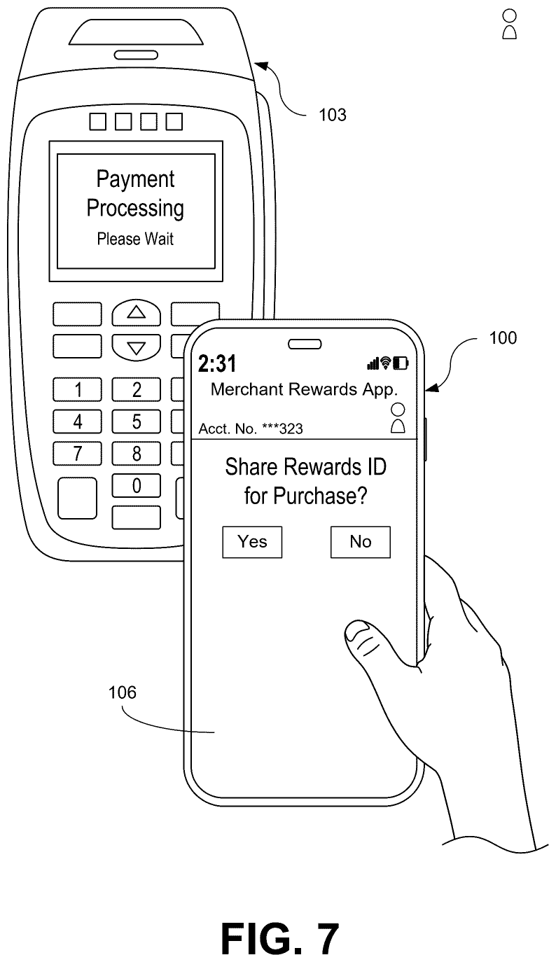

In some examples, once the merchant application has been opened on the client device 100, the user could be prompted again to consent to sharing his or her loyalty program information with the merchant. An example of such a prompt for consent is depicted in FIG. 7.

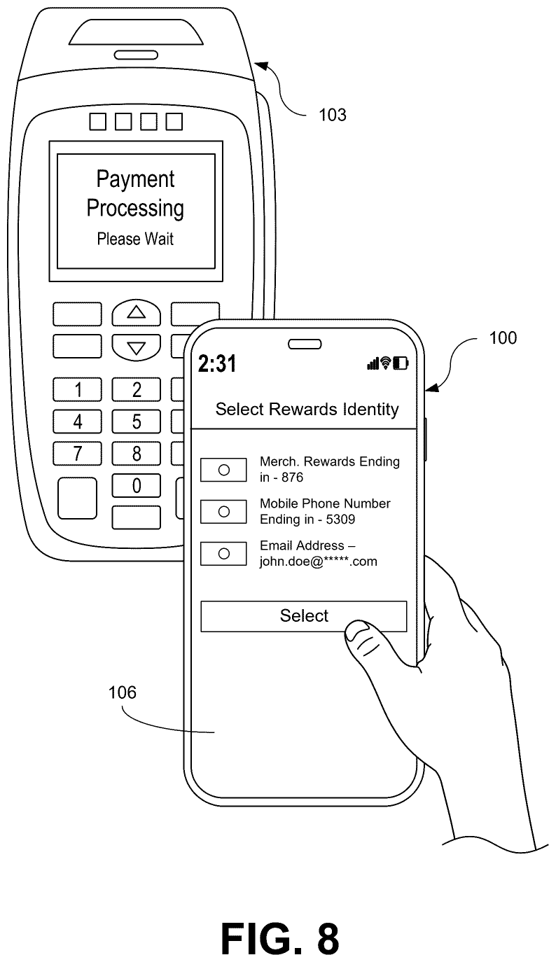

Alternatively, in some embodiments, the payment terminal 103 might not prompt the user of the client device 100 to open a merchant application installed on the client device, as depicted in FIGS. 6 and 7. Instead, the wallet application 1006 (FIG. 10) could store various user identifiers 1019 (FIG. 10). After being prompted to select a payment credential 1013 and/or digital identity documents 1016, as depicted in FIGS. 3 and 4, the user could then be prompted to select one or more user identifiers 1019 from a list of user identifiers 1019 stored by the wallet application 1006, as depicted in FIG. 8. The selected user identifier(s) 1019 could then be transmitted to the payment terminal 103 along with the payment credential 1013 and digital identity document 1016 (e.g., as depicted at FIG. 5). Embodiments such as those depicted in FIG. 6 could be used with merchants who use the email address or phone number of the customer as their identifier for the loyalty program.

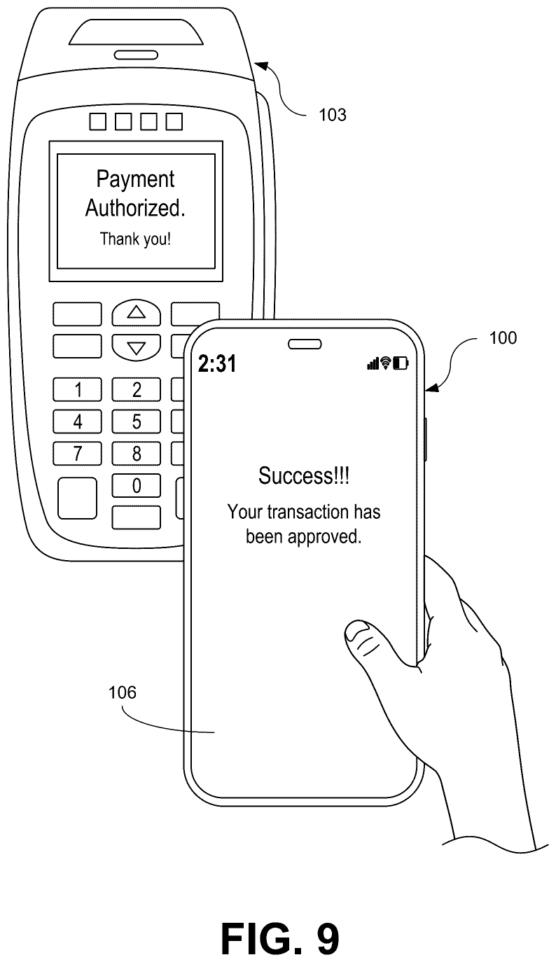

In any case, once the payment terminal 103 has received the requested or desired information from the wallet application 1006 of the client device 100, the payment terminal 103 could process the transaction. The status of the transaction could then be returned by the payment terminal 103 to the wallet application 1006, which could then cause the status to be shown on the display 106 of the client device 100, an example of which is depicted in FIG. 9.

With reference to FIG. 10, shown is a schematic block diagram depicting an example of the various embodiments of the present disclosure. As illustrated, a client device 100 and a payment terminal 103 can be in data communication with each other. For example, the client device 100 and the payment terminal 103 could have establish a wireless connection between the two devices using any one or more of various wireless communications protocols (e.g., near-field communications (NFC), ultra-wideband (UWB), BLUETOOTH, etc.).

The client device 100 is representative of a plurality of client devices that can be in data communication with the payment terminal 103. The client device 100 can include a processor-based computer system, such as a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), wearable computing device (e.g., smart watches, smart rings, etc.), or other devices with like capability. The client device 100 can include one or more displays 106, such as liquid crystal displays (LCDs), gas plasma-based flat panel displays, organic light emitting diode (OLED) displays, electrophoretic ink (“E-ink”) displays, projectors, or other types of display devices. In some instances, the display 106 can be a component of the client device 100 or can be connected to the client device 100 through a wired or wireless connection.

The client device 100 can also include one or more client radios 1003. The client radio 1003 can be configured to detect the presence of other devices (e.g., the payment terminal 103) that are enabled for wireless communication. For example, the client radio 1003 could be a near-field communication (NFC) radio capable of detecting other NFC enabled devices (e.g., the payment terminal 103) and obtain data from or provide data to the other NFC enabled devices. The client radio 1003 could also be configured to ultra-wideband (UWB), BLUETOOTH®, or similar protocols that allow for peer-to-peer wireless communication between devices.

The client device 100 can be configured to execute various applications such as a wallet application 1006, a merchant application 1009, or other applications. A wallet application 1006 could be developed and released by an issuer of a payment credential 1013 (e.g., a bank, brokerage, or other financial institution) or by a third-party (e.g., APPLE WALLET®, GOOGLE WALLET®, etc.). A merchant application 1009 application could be developed and released by the merchant operating the payment terminal 103.

The wallet application 1006 can be configured to store various items of date on behalf of the user and perform various actions on behalf of the user. For example, the wallet application 1006 can be configured to store payment information related to one or more payment credentials 1013 and make payments using the stored payment credentials 1013 on behalf of a user of the client device 100. The wallet application 1006 can also be configured to store one or more digital identity documents 1016 associated with the user and to provide any requested or required digital identity documents 1016 to the payment terminal 103 when performing a transaction.

The merchant application 1009 can be configured to provide various merchant related functions or services to the user of the client device 100. For example, the merchant application 1009 could be used to allow a user to shop online, schedule in-store pick-up or delivery of purchases, manage their user information on file with the merchant, manage their enrollment in and benefits from a loyalty program offered by the merchant, etc. Accordingly, the merchant application 1009 could store data on behalf of the user such as the user identifier 1019 assigned to the user by the merchant.

A payment credential 1013 can represent information necessary to make a payment using a payment instrument (e.g., checking account, credit card, debit card, stored-value card, etc.). For example, a payment credential 1013 could include the account number, expiration date, security code (e.g., card security code (CSC); card verification value (CVV); etc.), billing address, and/or name of the account owner. In some instances, these values could be tokenized or virtualized to protect the security of underlying payment instrument. For example, rather than store the actual credit card number, a virtual credit card number (sometimes referred to as a “payment token” or “token”) could be stored as part of the payment credential 1013. In some instances, multiple payment credentials 1013 could be cached by the wallet application 1006, such as when a user has multiple credit or debit cards associated with his or her name (e.g., because he or she has multiple personal credit or debit cards linked to his or her name; is an authorized user of one or more credit cards or debit cards; a combination thereof; etc.).

A digital identity document 1016 is a digital representation of an identity document issued by a third party, such as a government agency, corporation, etc. A digital identity document can include information about the user, as established or verified by the third party. The digital identity document 1016 can be cryptographically signed in order to authenticate the contents of the digital identity document 1016 and to prevent forgeries of the digital identity document 1016. In some instances, a digital identity document 1016 could be implemented as a verifiable credential issued by the third party and complies with the W3C's verifiable credentials standard. Examples of digital identity documents 1016 can include a mobile driver's licenses (MDL), such as an MDL compliant with the ISO/IEC 18013-5 standard, a digital passport, a digital health insurance card issued by a health insurance provider, an identifying credential issued by a trusted third-party (e.g., an identifying document issued by a financial institution that has performed know-your-customer (KYC) validation of the identity of the user), or other types of documents that could assert, verify, or validate the identity of the user.

A user identifier 1019 can represent any identifier that a merchant or operator of the payment terminal 103 uses to distinguish one customer with respect to another customer. For example, a merchant could issue separate, distinct, and/or unique user identifiers 1019 to each member of a loyalty program operated by the merchant, such as unique account numbers assigned to individual users. In another example, a merchant could use data provided by the user which can be used to uniquely identify the user, such as a mobile phone number, email address, or other piece of information. In some instances, a set of data could be used, where the set or tuple can uniquely identify a user (e.g., a combination of full name and phone number). These instances could be used where individual pieces of data might not be able to uniquely identify an individual (e.g., because two or more individuals share the same phone number, email address, mailing address, legal name, etc.), but the combination of data can uniquely identify an individual with respect to other individuals.

A user identifier 1019 can be stored in any of several locations, depending on the particular implementation of the present disclosure. For example, a user identifier 1019 could be stored by the merchant application 1009 to allow the user of the merchant application 1009 to interact with the merchant (e.g., to update his or her account, redeem loyalty points or rewards, check status, make purchases, make returns, etc.). In other instances, the wallet application 1006 could store one or more user identifiers 1019 associated with one or more respective merchants. In these implementations, the wallet application 1006 could store or cached the user identifiers 1019 in order to provide them to the payment terminal 103 as needed or requested in order to process a payment more quickly compared to implementations where the wallet application 1006 is required to request the user identifier 1019 from the merchant application 1009 during a transaction with the payment terminal 103.

The payment terminal 103 can represent any physical, hosted, or virtual terminal operable by a merchant that can interact with the client device 100 using a wireless communication protocol (e.g., NFC, UWB, BLUETOOTH, etc.) to authorize a payment for a transaction. A payment terminal 103 may be referred to as a credit card machines, card readers, PIN pads, or point of sale (PoS) terminal. Examples of payment terminals 103 include readers that communicate with a mobile application on a mobile device (e.g., smartphone, tablet, etc.), portable payment terminals 103 (e.g., handheld credit card machines), and dedicated or standalone payment terminals 103 (e.g., countertop readers integrated with a cash register).

The payment terminal 103 can also include one or more terminal radios 1023. The terminal radio 1023 can be configured to detect the presence of other devices (e.g., the client device 100) that are enabled for wireless communication. For example, the terminal radio 1023 could be a near-field communication (NFC) radio capable of detecting other NFC enabled devices (e.g., the client device 100) and obtain data from or provide data to the other NFC enabled devices. The terminal radio 1023 could also be configured to ultra-wideband (UWB), BLUETOOTH®, or similar protocols that allow for peer-to-peer wireless communication between devices.

The payment terminal 103 can be configured to execute various applications such as a terminal application 1026 or other applications. The terminal application 1026 can represent any application installed on the payment terminal 103 to authorize and process a payment for a transaction. Accordingly, the terminal application 1026 could be configured to communicate with the wallet application 1006 of the client device 100 using the terminal radio 1023 to obtain the payment credential 1013 and any other necessary information to process and authorize the payment. This can include requesting a digital identity document 1016 or one or more user identifiers 1019 according to various embodiments of the present disclosure.

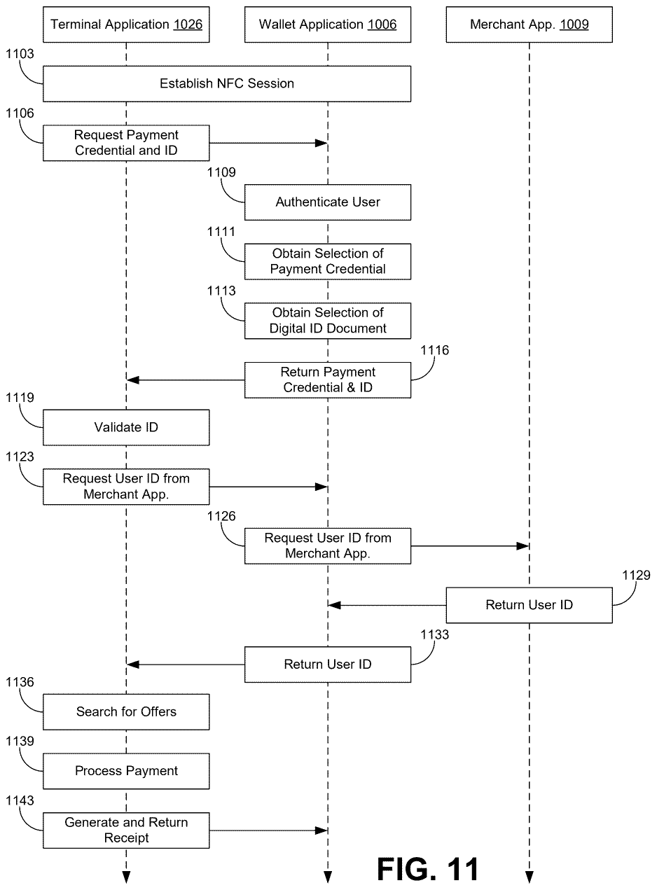

Referring next to FIG. 11, shown is a sequence diagram that provides one example of the operations of and interactions between portions of the wallet application 1006, merchant application 1009, and terminal application 1026. The sequence diagram of FIG. 11 provides merely an example of the many different types of functional arrangements that can be employed to implement the operation of the depicted portions of the wallet application 1006, merchant application 1009, and terminal application 1026. As an alternative, the sequence diagram of FIG. 11 can be viewed as depicting an example of elements of a method implemented between the client device 100 and the payment terminal 103.

Beginning with block 1103, the terminal application 1026 and the wallet application 1006 can establish a direct communications session with each other, such as when a user of the client device 100 attempts to make a payment for a transaction using the wallet application 1006 installed on the client device 100. For example, when the client device 100 is placed in proximity to the payment terminal 103, the terminal application 1026 and the wallet application 1006 could detect the presence of the respective client device 100 and payment terminal 103 through electromagnetic fields generated by the respective terminal radio 1023 and client radio 1003. The terminal application 1026 and the wallet application 1006 could then establish a communication session, such as an NFC communication session, with each other through the respective terminal radio 1023 and client radio 1003.

Moving on to block 1106, the terminal application 1026 can request a payment credential 1013 and one or more digital identity documents 1016. In some embodiments, the terminal application 1026 could specify the type of digital identity document 1016 required. In some instances, the terminal application 1026 could specify a particular digital identity document 1016 to be shared (e.g., a mobile driver's license). In other instances, the terminal application 1026 could specify one or more criteria that a digital identity document 1016 should satisfy (e.g., verify the age of the user). In instances where the request is sent via an NFC communication session, one or more portions of the request could be sent using customized (e.g., non-ISO 7816-4) NFC tags.

Next, at block 1109, the wallet application 1006 can authenticate the user of the client device 100. For example, the wallet application 1006 could perform biometric authentication (e.g., facial recognition, fingerprint scanning, voice recognition, etc.), prompt the user for a password, personal identification number (PIN), etc. Authentication can be performed in order for the wallet application 1006 to be able to assure that the user of the client device 100 is the same user identified by the digital identity documents 1016 stored on the client device 100 and/or is the same user authorized to make a purchase or transaction using the payment credentials 1013 stored on the client device 100.

In response to authentication of the user at block 1109, the wallet application 1006 can obtain a selection of a payment credential 1013 at block 1111. For example, the wallet application 1006 could present a selection of available payment credentials 1013 on the display 106 of the client device 100 with a prompt to the user to select a payment credential 1013 to use for the transaction.

Referring next to block 1113, the wallet application 1006 can obtain a selection of a digital identity document 1016. In some implementations, the wallet application 1006 could select the digital identity document 1016 automatically in response to the request from the terminal application 1026. For example, if there were only digital identity document 1016 stored on the client device 100, or only one digital identity document 1016 that matched a criterion specified by the terminal application 1026, then the wallet application 1006 could automatically select the digital identity document 1016. In these instances, the wallet application 1006 could show a prompt on the display 106 of the client device 100 to obtain user permission to share the selected digital identity document 1016. In other examples, such as those where multiple digital identity documents 1016 are stored on the client device 100, the wallet application 1006 could show a prompt on the display 106 of the client device 100 to obtain a selection of an appropriate digital identity document 1016 from the user. In these examples, the wallet application 1006 could preselect the digital identity documents 1016 that would satisfy the requirements of the transaction or the request received from the terminal application 1026, and the user could select a digital identity document 1016 to share from the set shown by the wallet application 1006.

Then, at block 1116, the wallet application 1006 could return the payment credential 1013 and digital identity document 1016 selected at blocks 1111 and 1113 to the terminal application 1026. In instances where the response is sent via an NFC communication session, one or more portions of the response could be sent using customized (e.g., non-ISO 7816-4) NFC tags that include one or more of the payment credential 1013 and/or digital identity document 1016.

Subsequently, at block 1119, the terminal application 1026 can validate the digital identity documents 1016 returned at block 1116. For example, the terminal application 1026 could verify that the cryptographic signature was generated using a signing key known to be associated with and/or controlled by the issuer of the digital identity document 1016 and that the hash of the digital identity document 1016 included in the cryptographic signature matches the digital identity document 1016. As another example, the terminal application 1026 could also determine whether the digital identity document 1016 has expired (e.g., if it represents an expired mobile driver's license or digital passport).

At block 1119, the terminal application 1026 could also evaluate the digital identity document 1016 to determine whether the transaction is allowed to proceed based at least in part on the digital identity document 1016. For example, if the transaction requires that a user be above a particular age, the terminal application 1026 could evaluate the digital identity document 1016 to determine if the user is old enough to proceed with the transaction. As another example, if the transaction requires that digital identity document 1016 specify a particular identity of an individual (e.g., the name on the digital identity document 1016 must match the name of a hotel reservation), then the terminal application 1026 could evaluate the digital identity document 1016 to determine if the name listed by the digital identity document 1016 matches the name required for the transaction.

If the validation or evaluation of the digital identity document is successful, then the process can proceed to block 1123. However, if the validation or evaluation of the digital identity document is unsuccessful, then the process could halt and the terminal application 1026 could cause the payment terminal 103 to display an error code or message (e.g., that the digital identity document 1016 is invalid or that the user is not authorized to proceed with the transaction using the digital identity document 1016 presented).

Moving on to block 1123, the terminal application 1026 could then request a user identifier 1019 representing the user (e.g., to determine whether the user is enrolled in a loyalty program with the merchant operating the terminal application 1026). For example, the terminal application 1026 could provide a deeplink to the wallet application 1006 that identifies the merchant application 1009. The deeplink could further specify that the user identifier 1019 stored by the merchant application 1009 is to be retrieved and shared with the wallet application 1006.

Next, at block 1126, the wallet application 1006 can request the user identifier 1019 from the merchant application. For example, the wallet application 1006 could follow the deeplink provided by the terminal application 1026 at block 1123.

Proceeding to block 1129, the merchant application 1009 could return the user identifier 1019 to the wallet application 1006. For example, if the merchant application 1009 were installed on the client device 100, then the deeplink could cause the wallet application 1006 to open the merchant application 1009 and obtain the user identifier 1019. Similarly, if the merchant application 1009 were not installed on the client device 100, the deeplink could cause the client device 100 to download and install the merchant application 1009 (e.g., from a mobile device application store such as the APPLE STORE® or GOOGLE PLAY® store). Once installed, the user could login to the merchant application 1009, or register as a new user of the merchant application 1009 to obtain a user identifier 1019, thereby causing the merchant application 1009 to share the user identifier 1019 by returning it to the wallet application 1006.

Then, at block 1133, the wallet application 1006 can return the user identifier 1019 received from the merchant application 1009 at block 1129.

Subsequently, at block 1136, the terminal application 1026 can use the user identifier 1019 to search for any applicable offers or discounts to apply to the transaction. For example, the terminal application 1026 could query a user database using the user identifier 1019 to see if there are any offers or discounts associated with the loyalty program account identified by the user identifier 1019. As another example, the terminal application 1026 could query the user database to determine if the user has any membership, rewards, or loyalty points earned from prior transactions that could be redeemed for a discount. In this example, if the user has membership, rewards, or loyalty points, the terminal application 1026 could prompt the user, via the payment terminal 103, the user to specify or confirm how many membership, rewards, or loyalty points, if any, that the user would like to apply to the transaction.

Moving on to block 1139, the terminal application 1026 can process the payment. For example, the terminal application 1026 could adjust the subtotal or total balance due based at least in part on any offers identified at block 1136 or any membership, rewards, or loyalty points redeemed for a discount. The terminal application 1026 could then submit a transaction authorization request to a payment network (e.g., credit card, debit card, or electronic funds transfer (EFT) network) associated with the payment credential 1013 provided by the wallet application 1006. If the transaction authorization request is approved by the issuer of the payment credential 1013, then the terminal application 1026 could receive a transaction authorization response indicating that the transaction has been approved by the issuer.

Then, at block 1143, the terminal application 1026 can generate a receipt representing the transaction and return the receipt to the wallet application 1006. The wallet application 1006 could store the receipt for record keeping purposes (e.g., if a return or exchange needed to be made in the future).

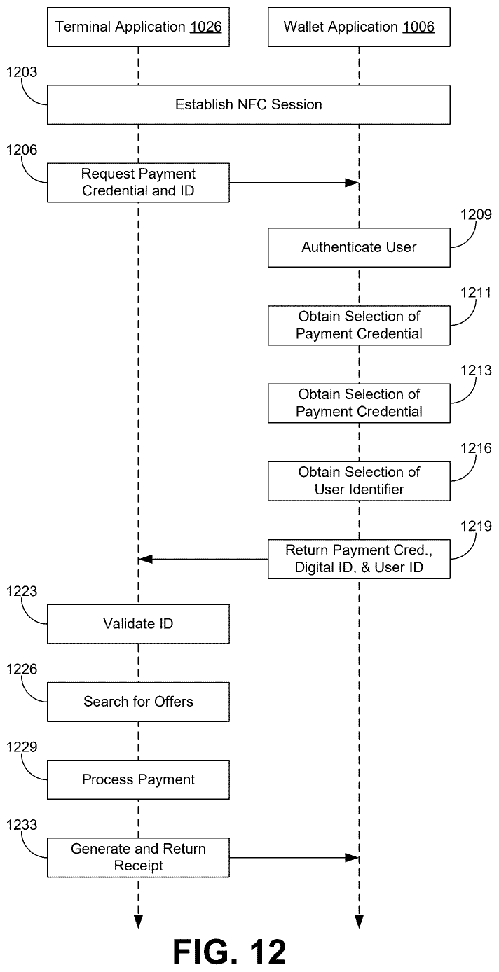

Referring next to FIG. 12, shown is a sequence diagram that provides one example of the operations of and interactions between portions of the wallet application 1006 and the terminal application 1026. The sequence diagram of FIG. 12 provides merely an example of the many different types of functional arrangements that can be employed to implement the operation of the depicted portions of the wallet application 1006 and the terminal application 1026. As an alternative, the sequence diagram of FIG. 12 can be viewed as depicting an example of elements of a method implemented between the client device 100 and the payment terminal 103.

Although many of the operations performed in the sequence diagram of FIG. 12 are similar to those performed in FIG. 11, embodiments such as those depicted in the sequence diagram of FIG. 12 are more efficient at processing the same transaction compared to embodiments such as those depicted in FIG. 11 because the embodiments of FIG. 12 can process the same transaction in fewer steps.

Beginning with block 1203, the terminal application 1026 and the wallet application 1006 can establish a direct communications session with each other, such as when a user of the client device 100 attempts to make a payment for a transaction using the wallet application 1006 installed on the client device 100. For example, when the client device 100 is placed in proximity to the payment terminal 103, the terminal application 1026 and the wallet application 1006 could detect the presence of the respective client device 100 and payment terminal 103 through electromagnetic fields generated by the respective terminal radio 1023 and client radio 1003. The terminal application 1026 and the wallet application 1006 could then establish a communication session, such as an NFC communication session, with each other through the respective terminal radio 1023 and client radio 1003.

Moving on to block 1206, the terminal application 1026 can request a payment credential 1013 and one or more digital identity documents 1016. In some embodiments, the terminal application 1026 could specify the type of digital identity document 1016 required. In some instances, the terminal application 1026 could specify a particular digital identity document 1016 to be shared (e.g., a mobile driver's license). In other instances, the terminal application 1026 could specify one or more criteria that a digital identity document 1016 should satisfy (e.g., verify the age of the user). In instances where the request is sent via an NFC communication session, one or more portions of the request could be sent using customized (e.g., non-ISO 7816-4) NFC tags.

Next, at block 1209, the wallet application 1006 can authenticate the user of the client device 100. For example, the wallet application 1006 could perform biometric authentication (e.g., facial recognition, fingerprint scanning, voice recognition, etc.), prompt the user for a password, personal identification number (PIN), etc. Authentication can be performed in order for the wallet application 1006 to be able to assure that the user of the client device 100 is the same user identified by the digital identity documents 1016 stored on the client device 100 and/or is the same user authorized to make a purchase or transaction using the payment credentials 1013 stored on the client device 100.

In response to authentication of the user at block 1209, the wallet application 1006 can obtain a selection of a payment credential 1013 at block 1211. For example, the wallet application 1006 could present a selection of available payment credentials 1013 on the display 106 of the client device 100 with a prompt to the user to select a payment credential 1013 to use for the transaction.

Referring next to block 1213, the wallet application 1006 can obtain a selection of a digital identity document 1016. In some implementations, the wallet application 1006 could select the digital identity document 1016 automatically in response to the request from the terminal application 1026. For example, if there were only digital identity document 1016 stored on the client device 100, or only one digital identity document 1016 that matched a criterion specified by the terminal application 1026, then the wallet application 1006 could automatically select the digital identity document 1016. In these instances, the wallet application 1006 could show a prompt on the display 106 of the client device 100 to obtain user permission to share the selected digital identity document 1016. In other examples, such as those where multiple digital identity documents 1016 are stored on the client device 100, the wallet application 1006 could show a prompt on the display 106 of the client device 100 to obtain a selection of an appropriate digital identity document 1016 from the user. In these examples, the wallet application 1006 could preselect the digital identity documents 1016 that would satisfy the requirements of the transaction or the request received from the terminal application 1026, and the user could select a digital identity document 1016 to share from the set shown by the wallet application 1006.

Moving on to block 1216, the wallet application 1006 can obtain a selection of the user identifier 1019 of the user. After being prompted to select a payment credential 1013 and/or digital identity documents 1016, as previously discussed, the user could then be prompted to select one or more user identifiers 1019 from a list of user identifiers 1019 stored by the wallet application 1006. For example, a user could select an email address, a phone number, etc. to provide to a merchant who uses the email address or phone number of the customer as their identifier for the loyalty program of the merchant.

Proceeding to block 1219, the wallet application 1006 could return the payment credential 1013, digital identity document 1016, and user identifier 1019 selected at blocks 1211, 1213, and/or 1219 to the terminal application 1026. In instances where the response is sent via an NFC communication session, one or more portions of the response could be sent using customized (e.g., non-ISO 7816-4) NFC tags that include one or more of the payment credential 1013, digital identity document 1016, and/or user identifier 1019.

Subsequently, at block 1223, the terminal application 1026 can validate the digital identity documents 1016 returned at block 1116. For example, the terminal application 1026 could verify that the cryptographic signature was generated using a signing key known to be associated with and/or controlled by the issuer of the digital identity document 1016 and that the hash of the digital identity document 1016 included in the cryptographic signature matches the digital identity document 1016. As another example, the terminal application 1026 could also determine whether the digital identity document 1016 has expired (e.g., if it represents an expired mobile driver's license or digital passport).

At block 1223, the terminal application 1026 could also evaluate the digital identity document 1016 to determine whether the transaction is allowed to proceed based at least in part on the digital identity document 1016. For example, if the transaction requires that a user be above a particular age, the terminal application 1026 could evaluate the digital identity document 1016 to determine if the user is old enough to proceed with the transaction. As another example, if the transaction requires that digital identity document 1016 specify a particular identity of an individual (e.g., the name on the digital identity document 1016 must match the name of a hotel reservation), then the terminal application 1026 could evaluate the digital identity document 1016 to determine if the name listed by the digital identity document 1016 matches the name required for the transaction.

If the validation or evaluation of the digital identity document is successful, then the process can proceed to block 1123. However, if the validation or evaluation of the digital identity document is unsuccessful, then the process could halt and the terminal application 1026 could cause the payment terminal 103 to display an error code or message (e.g., that the digital identity document 1016 is invalid or that the user is not authorized to proceed with the transaction using the digital identity document 1016 presented).

Next, at block 1226, the terminal application 1026 can use the user identifier 1019 to search for any applicable offers or discounts to apply to the transaction. For example, the terminal application 1026 could query a user database using the user identifier 1019 to see if there are any offers or discounts associated with the loyalty program account identified by the user identifier 1019. As another example, the terminal application 1026 could query the user database to determine if the user has any membership, rewards, or loyalty points from prior transactions that could be redeemed for a discount. In this example, if the user has membership, rewards, or loyalty points, the terminal application 1026 could prompt the user, via the payment terminal 103, the user to specify or confirm how many membership, rewards, or loyalty points, if any, that the user would like to apply to the transaction.

Then, at block 1229, the terminal application 1026 can process the payment. For example, the terminal application 1026 could adjust the subtotal or total balance due based at least in part on any offers identified at block 1136 or any membership, rewards, or loyalty points redeemed for a discount. The terminal application 1026 could then submit a transaction authorization request to a payment network (e.g., credit card, debit card, or electronic funds transfer (EFT) network) associated with the payment credential 1013 provided by the wallet application 1006. If the transaction authorization request is approved by the issuer of the payment credential 1013, then the terminal application 1026 could receive a transaction authorization response indicating that the transaction has been approved by the issuer.

Subsequently, at block 1233, the terminal application 1026 can generate a receipt representing the transaction and return the receipt to the wallet application 1006. The wallet application 1006 could store the receipt for record keeping purposes (e.g., if a return or exchange needed to be made in the future).

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor, a memory, and a near-field communications (NFC) radio; and
machine-readable instructions stored in the memory that, when executed by the processor, cause the computing device to at least:
authenticate a user of the computing device;
in response to authentication of the user, prompt the user to select a payment credential;
provide, to a payment terminal in data communication with the computing device through the NFC radio, the payment credential and a digital identity document associated with the user; and
receive, from the payment terminal, a receipt for a transaction, the receipt indicating that payment for the transaction was made with the payment credential and that an identity of the user was verified with the digital identity document.

2. The system of claim 1, wherein the machine-readable instructions that cause the computing device to authenticate the user of the computing device further cause the computing device to perform biometric authentication of the user of the computing device.

3. The system of claim 1, wherein the machine-readable instructions that cause the computing device to at least in response to authentication of the user, prompt the user to select the digital identify document associated with the user from a list of digital identity documents presented to the user.

4. The system of claim 1, wherein the digital identity document comprises a mobile driver's license.

5. The system of claim 1, wherein the machine-readable instructions further cause the computing device to at least:
receive, from the payment terminal, a deeplink to a third-party application; and
execute the third-party application identified by the deeplink.

6. The system of claim 5, wherein the machine-readable instructions further cause the computing device to at least:
receive, from the third-party application, a user identifier; and
provide, to the payment terminal, the user identifier.

7. The system of claim 1, wherein the machine-readable instructions further cause the computing device to at least:
prompt the user to select a user identifier from a plurality of user identifiers presented to the user; and
provide the user identifier to the payment terminal.

8. A method, comprising:
authenticating a user of a computing device that comprises a near-field communication (NFC) radio;
in response to authentication of the user, prompting the user to select a payment credential;
providing, to a payment terminal in data communication with the computing device through the NFC radio, the payment credential and a digital identity document associated with the user; and
receiving, from the payment terminal, a receipt for a transaction, the receipt indicating that payment for the transaction was made with the payment credential and that an identity of the user was verified with the digital identity document.

9. The method of claim 8, wherein authenticating the user further comprises performing biometric authentication of the user of the computing device.

10. The method of claim 8, further comprising, in response to authentication of the user, prompting the user to select the digital identify document associated with the user from a list of digital identity documents presented to the user.

11. The method of claim 8, wherein the digital identity document comprises a mobile driver's license.

12. The method of claim 8, further comprising
receiving, from the payment terminal, a deeplink to a third-party application; and
executing the third-party application identified by the deeplink.

13. The method of claim 12, further comprising:
receiving, from the third-party application, a user identifier; and
providing, to the payment terminal, the user identifier.

14. The method of claim 8, further comprising:
prompting the user to select a user identifier from a plurality of user identifiers presented to the user; and
providing the user identifier to the payment terminal.

15. A non-transitory, computer-readable medium, comprising machine-readable instructions that, when executed by a processor of a computing device that comprises a near-field communication (NFC) radio, cause the computing device to at least:
authenticate a user of the computing device;
in response to authentication of the user, prompt the user to select a payment credential;
provide, to a payment terminal in data communication with the computing device through the NFC radio, the payment credential and a digital identity document associated with the user; and
receive, from the payment terminal, a receipt for a transaction, the receipt indicating that payment for the transaction was made with the payment credential and that an identity of the user was verified with the digital identity document.

16. The non-transitory, computer-readable medium of claim 15, wherein the machine-readable instructions that cause the computing device to authenticate the user of the computing device further cause the computing device to perform biometric authentication of the user of the computing device.

17. The non-transitory, computer-readable medium of claim 15, wherein the machine-readable instructions that cause the computing device to at least in response to authentication of the user, prompt the user to select the digital identify document associated with the user from a list of digital identity documents presented to the user.

18. The non-transitory, computer-readable medium of claim 15, wherein the digital identity document comprises a mobile driver's license.

19. The non-transitory, computer-readable medium of claim 15, wherein the machine-readable instructions further cause the computing device to at least:
receive, from the payment terminal, a deeplink to a third-party application;
execute the third-party application identified by the deeplink;
receive, from the third-party application, a user identifier; and
provide, to the payment terminal, the user identifier.

20. The non-transitory, computer-readable medium of claim 15, wherein the machine-readable instructions, when executed by the processor, further cause the computing device to at least:
prompt the user to select a user identifier from a plurality of user identifiers presented to the user; and
provide the user identifier to the payment terminal.
